(19) United States
(12) Patent Application Publication
(10) Pub. No.: US 2006/0288943 A1
(43) Pub. Date: Dec. 28, 2006

(54) INFLATABLE PET BED

(76) Inventor: TUN-JEN KU, TAICHUNG (TW)

Correspondence Address: LAW OFFICE OF LIAUH & ASSOC., 4224 WAIALAE AVE, STE 5-388, HONOLULU, HI, 96816, US

(21) Appl. No.: 11/160,544

(22) Filed: Jun. 28, 2005

(51) Int. Cl. A01K 29/00

(52) U.S. Cl. 119/28.5

(57) ABSTRACT

An inflatable pet bed, in one embodiment, comprises a cup-shaped member including a circular, inflatable first air cushion as side walls, the first air cushion including an air inflation valve, and a circular cover put on the first air cushion; and a pad including a disc-shaped second air cushion including an air inflation valve, and a disc-shaped covering stuffed with the inflated second air cushion. The pad is fitted on a bottom of the inflated cup-shaped member. The invention has advantages of being ease of storage, shipping, or carrying after deflating, being capable of shaped to a desired shape, and the aesthetic shape can be maintained for a long period of time without being deformed.

### BACKGROUND OF THE INVENTION

1. Field of Invention

The present invention relates to pet beds and more particularly to an inflatable pet bed having advantages including being ease of storage and being capable of shaped to a desired shape.

2. Related Art

A conventional foam pet bed is shown in FIGS. 1 and 2. The bed comprises circular foam side walls 10, a circular cover 11 of fabric covered on the side walls 10, a disc-shaped foam bottom wall 12 snugly placed on a bottom surface 113 of the cover 11, and a disc-shaped covering 13 stuffed with the bottom wall 12. Inner and outer surfaces 111 and 112 are stuffed with the side walls 10 which are inserted thereinto from a circular opening defined between a circular stitched elastic strip 114 at bottom end of the outer surface 112 and a joining portion of the inner and bottom surfaces 111 and 113.

However, the prior art suffered from several disadvantages. For example, foam, as the material of the side walls 10 and the bottom wall 12, is susceptible to being permanently deformed after being pressed by a hard object for a relatively long period of time in, for example a shipping process. The deformed pet bed is visually unattractive. Moreover, the pet bed occupies much space in storage. Thus, the shipping cost of pet beds inevitably increases for the sake of protection. Otherwise, the pet beds may be permanently deformed due to above reason. In addition, such pet beds are not collapsible, resulting in difficulties of carrying them and pet(s) for outgoings. Further, shape variations of the pet beds are limited due to increased difficulties in cutting out from foam material. Thus, the need for improvement still exists.

### SUMMARY OF THE INVENTION

It is therefore an object of the present invention to provide an inflatable pet bed having advantages of being ease of storage, shipping, or carrying after deflating, being capable of shaped to a desired shape, and the aesthetic shape can be maintained for a long period of time without being deformed.

The above and other objects of the present invention are realized by providing an inflatable pet bed comprising a cup-shaped member including a circular, inflatable first air cushion as side walls, the first air cushion including an air inflation valve, and a circular cover put on the first air cushion; and a pad including a disc-shaped second air cushion including an air inflation valve, and a disc-shaped covering stuffed with the inflated second air cushion, wherein the pad is fitted on a central portion of the inflated cup-shaped member.

The above and other objects, features and advantages of the present invention will become apparent from the following detailed description taken with the accompanying drawings.

### BRIEF DESCRIPTION OF THE DRAWINGS

FIG. 1 is an exploded view of a conventional pet bed;

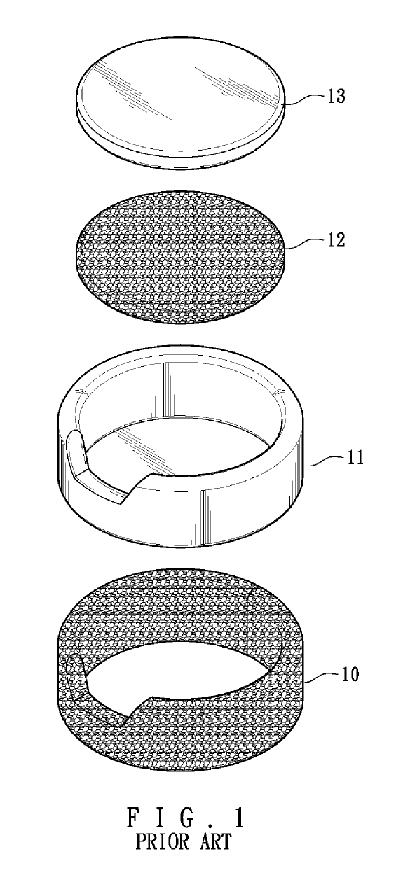

FIG. 2 is a longitudinal sectional view of the assembled pet bed shown in FIG. 1;

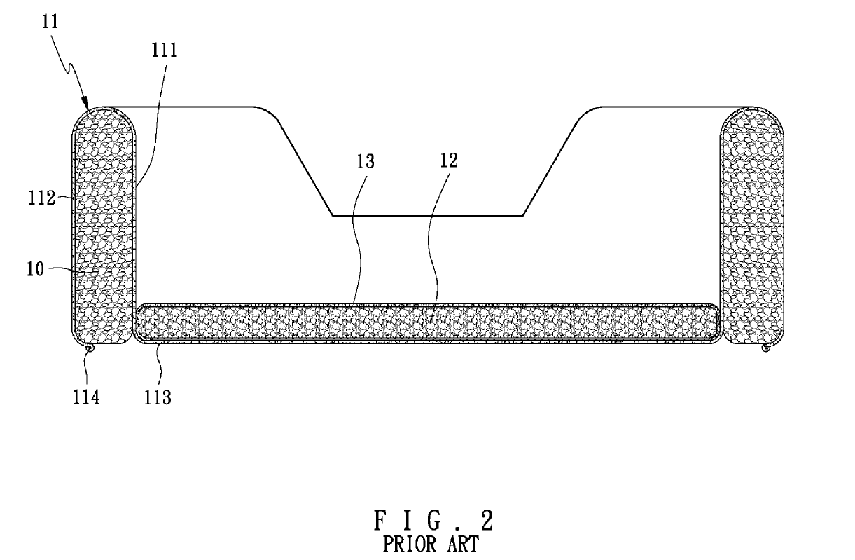

FIG. 3 is a front view of side walls as a portion of a preferred embodiment of inflatable pet bed according to the invention;

FIG. 4 is an exploded view of all constituent components of the pet bed shown in FIG. 3;

FIG. 5 is a longitudinal sectional view of the assembled pet bed shown in FIG. 4; and

FIG. 6 is a perspective view of the assembled pet bed shown in FIG. 4.

### DETAILED DESCRIPTION OF THE INVENTION

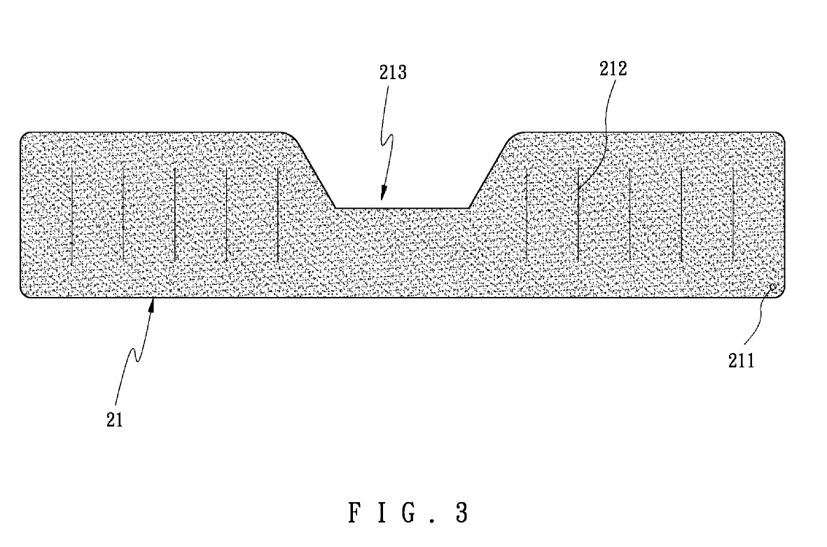

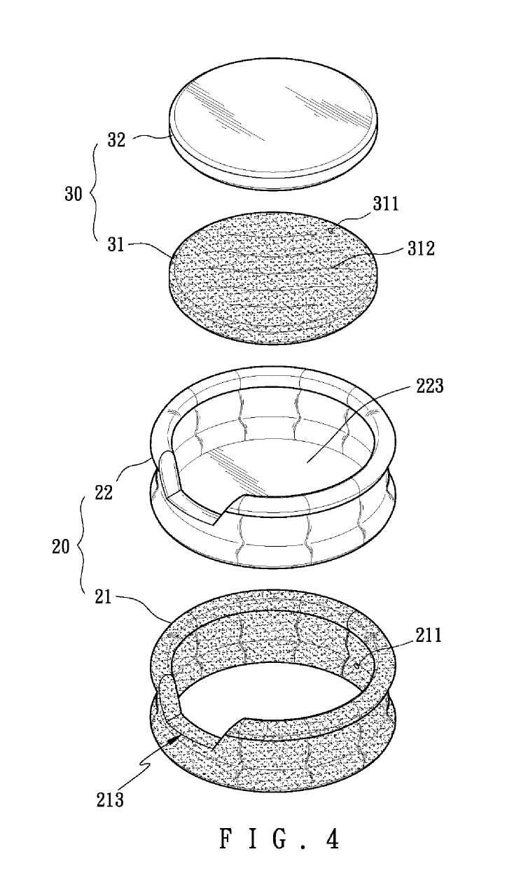

Referring to FIGS. 3, 4 and 5, an inflatable pet bed in accordance with a preferred embodiment of the invention comprises a cup-shaped member 20 and a pad 30. Each component is discussed in detailed below.

The cup-shaped member 20 comprises a circular, inflatable first air cushion 21 of fabric as side walls, the first air cushion 21 being sealed by radio frequency sealing and including an air inflation valve 211 on its outer surface, a plurality of longitudinal seams 212 formed around the outer surface for preventing the inflated first air cushion 21 from bulging along the outer surface, and a recess 213 open to top for pet access; and a circular cover 22 of fabric covered on the first air cushion 21. The inflated first air cushion 21 can be shaped as one of a plurality of predetermined ones as design. Inner and outer surfaces 221 and 222 of the cover 22 are put on the first air cushion 21 which as support of the pet bet, is inserted thereinto from a circular opening defined between a circular stitched elastic strip 224 at bottom end of the outer surface 222 and a joining portion of the inner and bottom surfaces 221 and 223.

The pad 30 comprises a disc-shaped second air cushion 31 of fabric, the second air cushion 31 being sealed by radio frequency sealing as bottom wall and including an air inflation valve 311 on its top surface and a plurality of transverse seams 312 formed on top and bottom surfaces for shaping the inflated second air cushion 31; and a disc-shaped covering 32 stuffed with the inflated second air cushion 31. The pad 30 is snugly placed on the bottom surface 223 of the cover 22 for forming the pet bed in response to inflating the first and second air cushions 21 and 31.

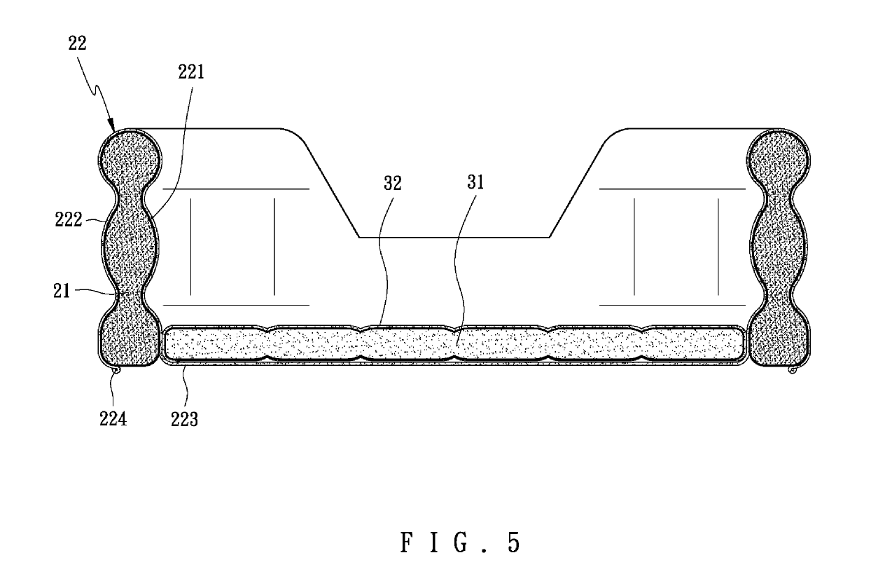

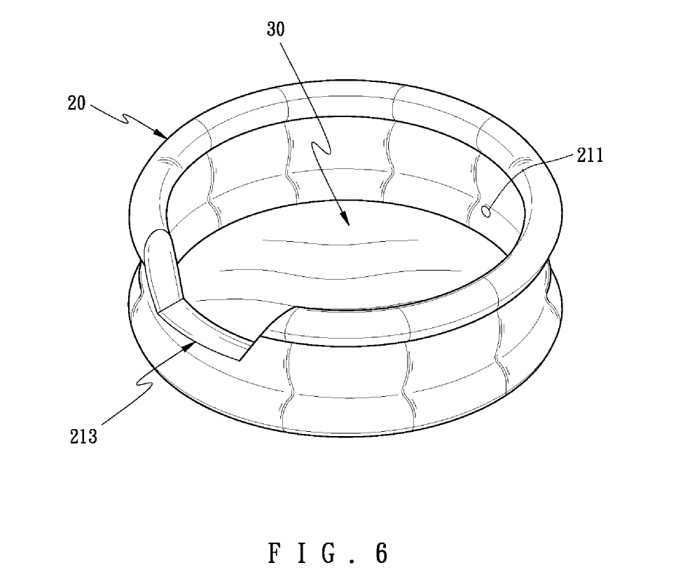

Referring to FIG. 6 in conjunction with FIG. 5, the inflated first and second air cushions 21 and 31 fills out a desired shape of the pet bed. Also, the aesthetic shape of the pet bed can be maintained for a long period of time without being deformed. Moreover, the purpose of being ease of storage, shipping, or carrying can be achieved after deflating the pet bed.

While the invention herein disclosed has been described by means of specific embodiments, numerous modifications and variations could be made thereto by those skilled in the art without departing from the scope and spirit of the invention set forth in the claims.

What is claimed is:

1. An inflatable pet bed comprising:
a cup-shaped member including a circular, inflatable first air cushion as side walls, the first air cushion including an air inflation valve, and a circular cover put on the inflated first air cushion; and
a pad fitted on a central portion of the cover.

2. The inflatable pet bed of claim 1, wherein the first air cushion further includes a plurality of longitudinal seams formed around an outer surface.

3. The inflatable pet bed of claim 1, wherein the first air cushion further includes a recess open to its top.

4. The inflatable pet bed of claim 1, wherein the cover includes inner and outer surfaces put on the first air cushion.

5. The inflatable pet bed of claim 4, wherein the cover further includes a bottom integrally formed with the inner surface.

6. The inflatable pet bed of claim 4, further comprising a circular stitched elastic strip formed at a bottom end of the outer surface such that the first air cushion is adapted to insert into the cover from a circular opening defined between the elastic strip and a joining portion of the inner surface and the bottom of the cover.

7. An inflatable pet bed comprising:
a cup-shaped member including a circular, inflatable first air cushion as side walls, the first air cushion including an air inflation valve, and a circular cover put on the first air cushion; and
a pad including a disc-shaped second air cushion including an air inflation valve, and a disc-shaped covering stuffed with the inflated second air cushion,
wherein the pad is fitted on a central portion of the inflated cup-shaped member.

8. The inflatable pet bed of claim 7, wherein the first air cushion further includes a plurality of longitudinal seams formed around an outer surface.

9. The inflatable pet bed of claim 7, wherein the first air cushion further includes a recess open to its top.

10. The inflatable pet bed of claim 7, wherein the cover includes inner and outer surfaces put on the first air cushion.

11. The inflatable pet bed of claim 7, wherein the second air cushion further includes a plurality of transverse seams formed on its top and bottom surfaces.
